(19) United States
(12) Patent Application Publication
(10) Pub. No.: US 2012/0109856 A1
(43) Pub. Date: May 3, 2012

(54) Enforcing foreign patents in state court

(76) Inventor: Matthew Arnold Bennett, Atlanta, GA (US)

(21) Appl. No.: 13/373,050

(22) Filed: Nov. 2, 2011

Related U.S. Application Data
(60) Provisional application No. 61/456,214, filed on Nov. 3, 2010.

(51) Int. Cl. G06Q 90/00

(52) U.S. Cl. 705/500

(57) ABSTRACT

A method of enforcing a foreign patent to stop foreign infringement is provided. The method includes a holder of a foreign patent suing an entity in a state court for infringing a foreign patent through its activities in the country which issued the foreign patent. Certain embodiments minimize negative effects on comity by suing the infringing entity in that entity's state of incorporation. In some embodiments, the foreign patent holder sues for infringement of multiple foreign patents against a single entity in the same state court case. In some embodiments, the foreign patent holder may sue the infringing entity in the Delaware Court of Chancery.

### CROSS-REFERENCE TO RELATED APPLICATIONS

This application claims the benefit of provisional patent application Ser. No. 61/456,214, filed 2010 Nov. 3 by the present inventor. This provisional patent application is incorporated herein by reference.

### STATEMENT REGARDING FEDERAL SPONSORED RESEARCH

Not Applicable

### NAMES OF PARTIES TO A JOINT RESEARCH AGREEMENT

Not Applicable

### SEQUENCE LISTING OR PROGRAM

Not Applicable

### BACKGROUND

1. Field

This invention relates generally to patent litigation, and more specifically to enforcing foreign patents against infringers.

2. Description of Prior Art

Inventors often patent a single invention in multiple counties. Generally a patent allows a patent holder to prevent the invention's use only within the country which issues the patent. For example, if an inventor only patents her invention in the United States, the U.S. patent gives the inventor no legal right to prevent others from using the invention in Australia. Such limited national enforceability reflects the territoriality principle of patent law. This principle often is reflected in national patent law, including in 37 U.S.C §271(a), which substantially limits the activities that constitute the infringement of U.S. patents to those occurring inside or directed at the United States.

Foreign manufacturing and increased worldwide demand for patented products incentivize the patenting of inventions in more than one country. Also, harmonization efforts have simplified the process required to file foreign patents.

Suing for infringement in a single country requires significant resources and effort. To enforce patents from more than one country against an entity that infringes in those countries, a patent holder typically would need to sue the infringing entity independently in each country where infringement occurred. Such multinational litigation is inefficient, burdensome, and costly. As a result, a patent holder faced with an entity or an entity and its affiliated entity usually concentrate litigation against the infringer in a single country before enforcing the other patents. Additionally, infringement cases take time to litigate. Even fast U.S. districts like the Eastern District of Texas take a year or more to reach judgment on U.S. patent infringement cases. Patent holders would prefer a faster and more comprehensive way to stop infringement.

For the foregoing reasons, there is a need for a more efficient way for patent holders to enforce patent rights. It would, therefore, be desirable to provide a solution that addresses these and other problems associated with enforcing foreign patents against infringers.

### SUMMARY

At the heart of the present invention is the discovery that a patent holder may sue an entity for infringing a foreign patent in state court. In accordance with the invention, then, a patent holder's ability to stop infringement of a foreign patent is improved by suing an entity for infringing a foreign patent in state court.

In the U.S. judicial system, federal courts have exclusive jurisdiction over cases involving U.S. patents. See 28 U.S.C. §1338(a) (“The district courts shall have original jurisdiction of any civil action arising under any Act of Congress relating to patents . . . Such jurisdiction shall be exclusive of the courts of the states in patent . . . cases.”). The grant of exclusively federal jurisdiction under 28 U.S.C. §1338 does not address patents issued by foreign governments.

In some embodiments, the infringer may be deemed a citizen of the same state as the patent holder under 28 U.S.C. §1332. In some embodiments, the patent holder may assert more than one foreign patents infringement claims against an entity in the same state court case.

In some embodiments, the federal district court to which the case would be removed if a defendant successfully had the state court case removed to federal district court would be subject to federal appellate review by the Court of Appeals for the Third Circuit. In some embodiments of the invention, the state court is the Delaware Court of Chancery.

The remedy sought against a infringer may include an injunction, monetary damages, or other forms of equitable relief.

### DESCRIPTION OF THE DRAWINGS

Not applicable

### DETAILED DESCRIPTION

Enforcing foreign patents against an entity that infringes in multiple countries can be burdensome and complicated. Generally the territoriality principle limits activities that constitute patent infringement those acts occurring inside the issuing country's physical boundaries. The traditional forum for patent infringement cases is a court in the country which both (a) issued the asserted patent and (b) is located where the infringement occurred.

A patent holder usually brings cases alleging infringement of a U.S. patent in U.S. federal district court. Alternatively, holders of U.S. patents can assert those patent rights in Section 337 (19 U.S.C. §1337) investigations before the U.S. International Trade Commission or in arbitration against an infringer. Both Section 337 investigations and arbitration are used less often than district court, as Section 337 investigations have strict factual requirements and custom procedures, while arbitration requires consent of the opposing party.

Additionally, if a holder of a patent issued by a foreign country wished to assert that foreign patent to stop an entity from using the invention in the issuing country, the holder could sue the infringer in a court in the issuing country.

If faced with an entity that infringes a patent holder's patents on a single invention issued by one or more countries, the previously used forums to litigate those matters are resource intensive, time consuming, and expensive. As noted above, it remained for the present inventor to recognize that an entity could be sued in state court for infringing a foreign patent based on infringing activity occurring outside of the U.S., which would provide numerous benefits as detailed herein.

In accordance with the present invention, the patent holder sues an entity in state court for infringing a foreign patent. The following description will provide a better understanding of the nature and advantages of the present invention.

28 U.S.C. §1338, which addresses the federal judiciary's exclusivity over patent cases arising under an Act of Congress, does not grant federal courts exclusive jurisdiction over matters involving patents created by foreign law. Whereas federal courts are established under federal law, state courts generally are established under the authority of an individual state or U.S. territory. Additionally, state courts include those courts in U.S. territories or federal districts that function as a substitute for state courts (e.g., the Superior Court of the District of Columbia and the High Court of American Samoa).

State courts often hear cases involving activity occurring outside the court's jurisdiction. In those circumstances, state courts apply that court's choice of law principles to determine which substantive law will govern the dispute.

In some embodiments, the patent holder asserts in the state court case that the infringing entity infringed more than one foreign country's patent.

In some embodiments, the patent holder and at least one defendant are deemed citizens of the same state under 28 U.S.C. §1332. Trying foreign patent infringement cases in a jurisdiction other than in the issuing country risks dismissal out of concerns over comity and forum non conveniens. Those concerns are reduced if parties to the case are citizens of the same state. Additionally, eliminating diversity of citizenship reduces a potential way by which the defendant could try to remove the case to federal court.

In some embodiments, the patent holder seeks equitable remedies against a defendant. In some embodiments, the patent holder seeks damages for the defendant's infringement.

States typically have courts of general jurisdiction, some of which serve as both courts of law and courts of equity. Some states also have courts with specific jurisdiction as courts of equity. In some embodiments, the patent holder seeks to enjoin the defendant from infringing activity in a foreign country.

In some embodiments, the state court is located in a state where, if the defendant successfully removed the case to federal district court, the case would be heard by a federal district court subject to appellate review by the United States Court of Appeals for the Third Circuit. For most matters, appeals of decisions made by the federal district courts of Delaware, New Jersey, and Pennsylvania would be reviewed by the United States Court of Appeals for the Third Circuit. Unlike matters involving U.S. patent law, which generally are subject to appellate review by the Court of Appeals for the Federal Circuit, federal district court cases involving primarily foreign patent infringement would probably be reviewed by a federal Court of Appeals for the regional circuit. See Christianson v. Colt Industries, 486 U.S. 800 (1988). The Third Circuit previously held that foreign patents are not sufficiently governmental activities in nature to invoke the Act of State doctrine. Mannington Mills v. Congloeum, 595 F.2d 1287 (3rd Cir. 1979). Trying a foreign patent infringement case in a federal district court subject to Third Circuit precedent may reduce the risk of dismissal resulting by the Act of State doctrine.

In some embodiments, the court is the Chancery Court of Delaware. The Chancery Court fo Delaware can hear equitable matters quickly. Additionally, many corporations are incorporated in Delaware. Trying a foreign patent infringement case in the state of incorporation of both parties could reduce the potential offense to other nations posed by adjudication involving foreign patents, as well as reducing the chances of a court dismissing the case for forum non conveniens.

Courts generally require personal jurisdiction over a defendant to decide a case involving that defendant. Personal jurisdiction may be extended from one entity to a related, affiliated, or subsidiary entity by piercing the corporate veil of the second entity. Other acts or properties of an entity can give the court personal jurisdiction over an entity.

In some embodiments, the patent holder sues an entity and one or more affiliated entity for infringing one or more foreign patent.

As used herein, “state court” refers to a court established under the authority of any one of the individual states of the United States of America. State courts also include those courts in U.S. federal districts or territories (e.g., Washington D.C., Puerto Rico) established as a substitute for traditional state courts (e.g., the Superior Court of the District of Columbia and the High Court of American Samoa). “Entity” refers to a natural person, legal person, corporation, or other business organization. An “affiliated entity” to a first entity is any corporation, partnership or second entity in which the first entity directly or indirectly owns half or more of the voting interest or otherwise can direct the second entity's actions. “Bringing a lawsuit” includes asserting a civil action, filing suit, or filing a complaint in court. “Asserting a claim” includes raising a claim in a lawsuit, bringing a counterclaim, or bringing a crossclaim in a case.

“Patent holder” refers to an entity capable of enforcing a patent right, including an inventor who retained ownership of the invention or an assign. “Foreign patent” means a patent issued by a country other than the United States. “State” means any one of the individual states of the United States of America (e.g., Alabama, Alaska). “Lawsuit” means a civil action brought in a court of law or a court of equity. “Parties” to a lawsuit include each plaintiff and each defendant in the lawsuit. A “party” to a lawsuit is a defendant or plaintiff in that lawsuit. “U.S.” means United States.

Many other ramifications and variations are possible within the teachings of the invention. Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

### SEQUENCE LISTING

Not Applicable

What is claimed is:

1. A method of enforcing a foreign patent comprising bringing a lawsuit in a state court against an entity for infringing said foreign patent.

2. The method of claim 1, wherein the parties of said lawsuit lack complete diversity of citizenship under 28 U.S.C. §1332.

3. The method of claim 1, further comprising the step of asserting a claim against an affiliated entity to the first entity in said lawsuit.

4. The method of claim 1, wherein said entity is incorporated in a state selected from the group consisting of Delaware, Pennsylvania, and New Jersey.

5. The method of claim 1, wherein said state court is located in a state selected from the group consisting of Delaware, Pennsylvania, and New Jersey.

6. The method of claim 1, wherein said state court is the Chancery Court of Delaware.

7. A method of enforcing a foreign patent comprising asserting a claim in a state court against an entity for infringing said foreign patent.
